(19) United States
(12) Patent Application Publication
(10) Pub. No.: US 2003/0095302 A1
(43) Pub. Date: May 22, 2003

(54) Determination of transmission blockage in an optical telecommunication system

(76) Inventors: John J. Schuster, Bellevue, WA (US); Jeffrey C. Adams, Seattle, WA (US); John A. Bell, Issaquah, WA (US); Gerald E. Tourgee, Convent Station, NJ (US)

Correspondence Address: Lisa N. Benado, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/888,244

(22) Filed: Jun. 23, 2001

(51) Int. Cl. H04J 14/00; H04B 10/00; H01S 3/00; G02F 2/00; G02F 1/00

(52) U.S. Cl. 359/109

(57) ABSTRACT

An optical communication system is provided that has a network including a transmitter station that conveys data through a wireless pathway to a receiver station. An obstruction of the pathway is determined by measuring the attenuation of an optical beam arriving at or intending to arrive at a target receiver station and comparing the value with the attenuation of other optical beam(s) arriving at or intending to arrive at one or more reference receiving stations in the optical communication system. The values are interpreted to determine the nature of the blockage and various parameters in the optical data transmission system controlled according to the presence of a local blockage or global blockage. A further consideration in determining the type of blockage may be through measuring the backscattering of the optical beam. In addition, other aspects of the present invention relating to the storage and transfer of selected transaction data are described.

### FIELD OF THE INVENTION

The present invention relates generally to optical free space telecommunication systems and more particularly but not exclusively, relates to determining a blockage of an optical transmission in a network and optionally determining the nature of the blockage.

### BACKGROUND

With the increasing popularity of wide area networks, such as the Internet and/or World Wide Web, and local area networks, users continue to demand faster access through the networks. Furthermore, an increasing load as well as complexity of information that is transmitted requires increased capacity for the network systems.

A solution to these needs is the use of optical free space telecommunications technology to transmit optical signals across wireless free space pathways. Such optical telecommunications utilize a beam of light as an optical communications signal with data encoded into the beam and then sent through a free space pathway from a transmitter to a remote receiver. Optical communication systems are capable of much higher data rates than traditional radio frequency (RF) systems. For example, point-to-point laser communications may use a narrow optical beam that has the potential for very large data gathering capacity and high directivity to efficiently focus the light onto the receiver. High directivity may result in greater security and lower probability of interception.

It is important for these free space optical communication systems to set parameters that ensure general safety. There are several designated classes for types of optical exposures and associated safety standards established by organizations, such as the American National Standards Institute, American National Standard for Safe Use of Lasers, ANSI Z136.1-2000 (2000), New York, N.Y., as enforced by Occupational Safety and Health Association (OSHA); the Food and Drug Administration (FDA), Center for Devices and Radiological Health (CDRH), Performance Standards For Light-Emitting Products, Code of Federal Regulations (CFR), Volume 21, Part 1040, Subpart 10, Subchapter J; and International Electrotechnical Commission (IEC) International Standard, Safety of Laser Products, Part 1, Equipment Classification Requirements and User's Guide, IEC 60825-1, Amendment 2 (2001-01) Geneva, Switzerland. The standards may suggest how to apply lasers, laser product requirements, such as power levels, maximum permissible exposure (MPE), etc. Power requirements may vary for optics that are exposed to an unaided eye versus aided eye, e.g. use of a magnifying device, such as binoculars or a telescope.

Another consideration in employing optical communication systems is the occurrence of a blockage in the pathway of the optical beam. Such interference may significantly or even totally reduce the amount, i.e. power, of light reaching the receiving end of the pathway. Another potentially resulting problem is a loss of accurate directivity where, for example, a tracking mechanism fails to maintain focus onto the intended point of reception.

The systems attempt to optimize the transport of the optical data during changes in conditions in the environment. Often it is preferable to increase or decrease the power of an optical beam to comply with the safety guidelines. It is also preferable to project the light at a low level that also maintains adequate link margin in order to prolong equipment life. The nature of the blockage may profoundly affect the type of changes that the system may make in response to the blockage to provide safety measures and preserve link margin of the system. In addition, systems which attempt to sense blockages by use of detectors, must be able to distinguish between actual blockages of the pathway and other signals, such as variations of background light and light generated from other sources, such as other optical beams being projected in the network.

Prior optical communications systems fail to accurately detect blockages or provide sufficient information about a blockage in order to make appropriate changes in the system. In particular, currently available systems do not distinguish the nature of the blockage.

### SUMMARY

The present invention provides a determination of a blockage present in a free space optical communication system that transmits an optical beam carrying data into a wireless pathway to a target receiver station in a network. Attenuation of the optical beam intended for receipt by a target receiver station is detected and compared with an attenuation of another optical beam intended for receipt by at least one reference receiver station in the network to determine a global blockage or local blockage of the pathway. The assignment of receiver stations as being target receiver stations or reference receiver stations can be dynamically varied, where any given receiver station that is intended to receive any optical beam of interest, is designated for the purpose of blockage assessment as a target receiver station.

Furthermore, at times, various system parameters may be changed based on the type of blockage. Where the blockage affects much or all of the area surrounding the pathway and network, it is considered global in character, such as conditions due to weather events. In some instances, it may be preferable for the system to increase the power of the optical beam to overcome the resulting attenuation from the global blockage. However, if the blockage is an obstruction that is significantly localized to the pathway, such as a person, it may be a local blockage. In this case, it may be desirable to decrease power or resist increasing power, so as to lessen the blockage's exposure to the beam. Moreover, if the source of the disruption is temporary, as is often the case with a local blockage, then an immediate and large increase in power in attempts to permeate the obstruction may result in sudden overexposure and saturation of the receiver if the blockage quickly departs. By contrast, a global blockage often gradually decreases the beam's attenuation, so that an increase of power during the blockage is associated with less risk of saturating the receiver. After decreasing power due to a local blockage, the beam power may be incrementally increased or pulsed at increasing power amounts if no local blockage is found by repeatedly checking for the blockage, e.g. detecting attenuation and comparing the target and reference attenuation, until the power reaches a network based optimal amount.

In one embodiment of the communication system, backscatter is measured as an indication of a local or global blockage. In some instances, the optical beam may be transmitted by pulsing and only the backscatter during an extended period of time corresponding to backscatter from a global blockage is detected. In still further cases, backscatter may be distinguished from a local blockage and backscatter from the receiving station by the measured amount of backscatter from the intended beam with known transmitted power amounts from the transmitting and receiving stations. Modulation of the optical beam being transmitted may further distinguish between backscattering and other light, such as an optical beam projected from another station to the transmitter station.

The optical communication system often includes a network of multiple stations, including at least two reference receiver stations, and usually 5 to 50 reference receiver stations. In one embodiment, a reference receiver station is native, i.e. within, a transmitter station. Attenuation of another optical beam intended for this native reference receiver station may be detected prior to detecting the attenuation at the target receiver station. The network may also include a central station for sending instructions to the transmitter station or receiver station to adjust a system parameter according to whether the blockage is local or global.

### BRIEF DESCRIPTION OF THE DRAWINGS

The present invention is illustrated by way of example that is not intended for limitation, in the figures of the accompanying drawings, in which:

FIGS. 1A and 1B are block diagrams of one embodiment of an optical telecommunications system, in accordance with the teachings presented herein, wherein in FIG. 1A a local blockage is present and in FIG. 1B a global blockage occurs.

FIG. 2 illustrates one embodiment of a transmitter station according to the present invention.

FIGS. 3A, 3B and 3C illustrate various views of one embodiment of a receiver station, wherein FIG. 3A is an external view of a receiver station and FIG. 3B is an internal view of the receiver station of FIG. 3A, and FIG. 3C is an expanded internal view of a detecting end of the receiver station, in accordance with the teachings herein.

FIG. 4 illustrates one embodiment of an optical telecommunication system with a transmitter station having multiple native reference receiver stations, in accordance with the teachings herein.

FIG. 5 is a flow chart depicting one method for determining the nature of a blockage, according to the present invention.

FIGS. 6A, 6B and 6C are graphs of some examples of backscatter received by a monitor with a voltage over a period of time, wherein FIG. 6A represents the backscatter from a local blockage, FIG. 6B represents backscatter from a global blockage, and FIG. 6C represents backscatter from a modulated optical beam.

FIG. 7 illustrates one embodiment of backscatter from a local blockage interfering with an optical beam and backscatter from an optical beam reflecting from a receiver station, according to the present invention.

FIGS. 8A, 8B, 8C and 8D show various embodiments of interconnected communications system having multiple reference receiver stations, wherein FIGS. 8A and 8C represent examples of a local blockage and FIGS. 8B and 8D represent a global blockage, according to the teachings presented herein.

FIG. 9 is a block diagram of a machine-readable medium storing executable code and/or other data to provide one or a combination of mechanisms to determine a blockage and its nature and adjust system parameters accordingly, in accordance with one embodiment of the present invention.

### DETAILED DESCRIPTION

An optical communication system is provided having interconnected stations for communicating data. The system includes at least one transmitter station to convey data through a wireless pathway to a receiver station. An obstruction of the pathway is determined by measuring the attenuation of an optical beam arriving at a receiver station. The measurement may be further compared with the attenuation of other optical beam(s) arriving at one or more other receiving stations in the optical communication system. The received power amounts are interpreted to determine the nature of the blockage. The blockage character may be considered in controlling various parameters in the optical data transmission system, for example, by allowing high power operation during global blockage conditions to permit the system to operate with a greater margin without compromising safety as could result when a local blockage is present.

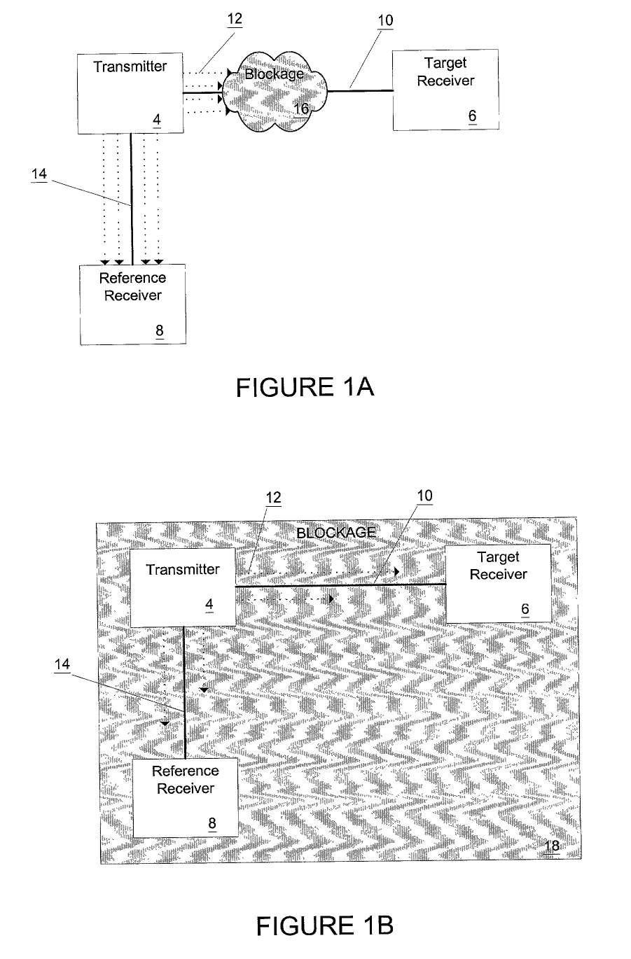

FIGS. 1A and 1B illustrates one example of an optical communications system 2 in which a primary transmitter station 4 prepares optical beam(s) and conveys a primary optical beam 12 along a target pathway 10 to a target receiver station 6. Furthermore, the optical communications system 2 includes at least one reference receiver station 8 to accept another optical beam 16 traveling down the length of a reference pathway 14. The optical beam 16 directed to the reference receiver station is independent of the optical beam 12 intended for the target receiver station 6. The reference receiver station 8 has the same or similar components as the target receiver station for accepting an optical beam 16 that is discrete from the primary optical beam 12 when released into a pathway. In one embodiment, the reference receiver station 8 is a site that is separate and remote from the target site within the network of the optical communications system. In another embodiment, a reference receiver station 8 may be combined within the primary transmitter station.

As illustrated in FIG. 1A, a local blockage 18 may occur to obstruct the target pathway 10 and inhibit some of or the entire optical beam from reaching the target receiver 6. A local blockage may include an object, such as a person; an animal; a vehicle; any moveable item; or the like, that happens across a point along the pathway and causes attenuation of the received beam intended for the target receiver station. For example, where the communication system relays an optical beam at an elevated distance from the ground, the local blockage may be a window washer or other worker on a building ledge, a bird, a helicopter, a kite, fallen debris, etc. A local blockage may occur at a single pathway in the system network, or be localized within a small percentage of the pathways in the system, such as two or more pathways that are close to each other, e.g. parallel, intersecting or otherwise within a proximal area at the point of the local blockage.

In some instances as depicted in FIG. 1B, a global blockage 20 may occur to cause at least partial attenuation of the optical beam 12 intended to reach the target receiver station 6 and the optical beam 16 to reach the reference receiver station 8. A global blockage is an obstruction that is distributed across the pathways leading to at least one other, and usually many or all of the receiving stations in the optical communications system. Commonly, the global blockage includes impedances brought on by such as fog, snow, rain, haze, other weather conditions that involve particles in the air that cause absorption, scattering, scintillation, and the like. The global blockage may also include pollution, smog, smoke, etc.

Although FIGS. 1A and 1B demonstrate one layout of an optical communications system, the scope of the present invention anticipates that the optical communications system may communicate with any number of reference receivers, e.g. 1 or 2 to 100, and transmitters arranged in various fashions within the communications system. Furthermore, the transmitter station(s) and/or receiver station(s) may also be transceivers, i.e. functional to both transmit optical beams and receive optical beams. Usually, a local blockage occurs at a single pathway to a target receiver, and only a second pathway to a reference receiver need be assessed to determine the nature of the blockage. In another embodiment, a local blockage occurs at two pathways in the system and attenuation values at a third or multiple reference receivers are used to determine the nature of the blockage.

The optical beam 12 transported through the optical communication system may have data system management information, e.g. status information and control signals, and/or other information, modulated thereon. The optical beam may be monochromatic or any wavelength or color, and may include visible light as well as ultraviolet or infrared portions of the spectrum. In one embodiment, the optical beam has a wavelength of about 1500-1600 nm, e.g. about 1550 nm, and a transmit divergence of about 0.8 mrads (milli radians).

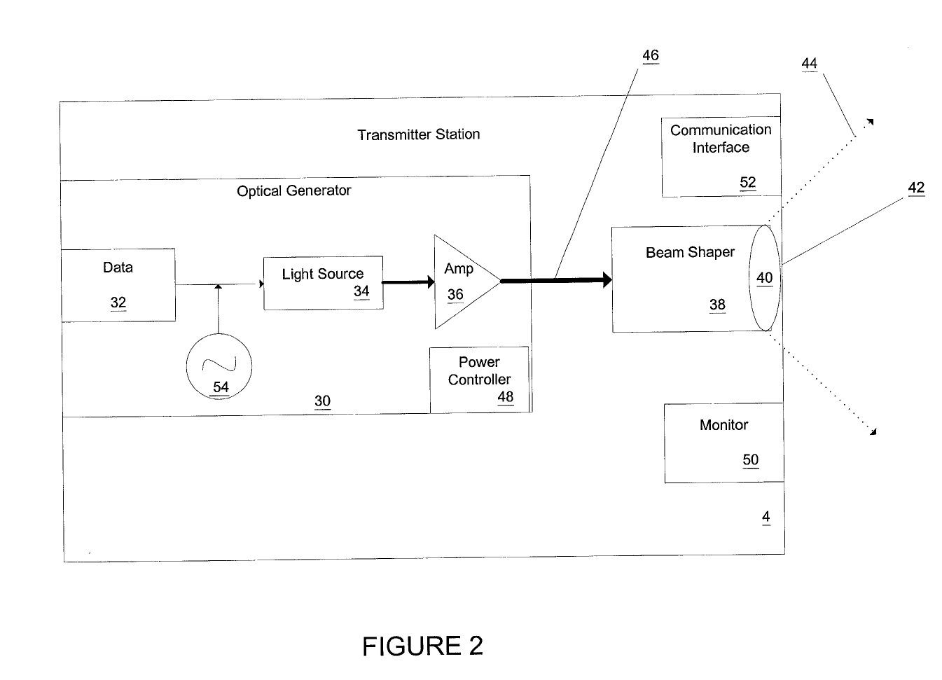

As shown in FIG. 2, the transmitter station 4 may have an optical generator 30 to create an optical beam that carries data and a releasing end 56 that has components to shape and send the beam into a pathway. The generator may include a data source 32 for supplying digital data to a light source 34 to be integrated into an optical beam. The data is any information that a user may desire to be transferred to a receiver. The optical beam may incorporate the data through any of several conventional techniques, such as on/off keying, for example, in which a “one” may be indicated by the light on and a “zero” by the light off, or vice-versa. Other techniques include phase encoding and frequency encoding. A modulator 54 may be used to affect the electrical signal of the optical beam. For example, the modulator may be used to superimpose a modulation onto the signal from data source 32 to partially or substantially fluctuate the power of the optical beam to facilitate phase, frequency, or amplitude encoding. Furthermore, a modulator, such as a mechanical chopper or an electro-optical modulator, may also be included after light source 34 to fluctuate the wave front, polarization, phase, amplitude, or the like, of the beam and assist in encoding.

The light source 34, e.g. a laser, generates an optical beam that is usually a modulated and encrypted, high-speed (10 Mpbs-10 Gbps) optical beam. A laser as the light source, such as a suitable commercially available distributed feedback (DFB), may be powered by an electronic drive signal.

The optical generator 30 portion of the transmission source may also optionally include an amplifier 36 to increase power of the optical beam 44. One exemplary amplifier is an erbium doped fiber amplifier (EDFA).

The releasing end 56 is in communication with the optical generator 30 to further prepare the beam for sending into a pathway. The releasing end often includes beam-shaping unit 38, such as a telescope, that may be coupled to the optical generator to form the appropriate wave front of the optical beam to optimize the transfer and receipt of the optical beam by the receiving station. In some cases, the beam shaping unit may make the optical beam nearly collimated and with a small angle of divergence. For example, the beam may have 0.8 mrad divergence after leaving the shaping unit. The beam-shaping unit often includes at least one lens, mirror or diffractive optical element 40 for shaping the beam. There may also be a filter, e.g. an adjustable filter wheel, located within or after the shaping unit and prior to the exit of the transmitter station. In some embodiments, a beam splitter is present to divide the beam prior to sending. Also connected to or after the beam-shaping unit 40 is a transmitter aperture 42 through which the optical beam 44 released into the pathway.

The light may travel within the transmitter station to the components of the transmitter station through a variety of transport mechanisms. For example, the light may move from the light source and to the amplifier and/or beam shaping unit through a fiber 46 running between the components, through free space or with the assistance of mirrors to direct the movement, etc. The components may be also coupled in various orders in addition to the arrangement shown in the figure. Furthermore, in one embodiment, all or some of the components of the optical generator are not disposed within the transmitter station, but are located external to the transmitter station and the light or data signals travel into the transmitter station.

The transmitter station may also have other optional components to assist in producing or processing an optical beam, for acquiring and analyzing control signals, reference data, backscattering, background light, etc. Furthermore, the transmitter station may include the components of a receiver station for receiving an optical beam from another transmitter station, or other components. For example, in one embodiment, the transmitter station also has a power controller 48 for increasing or decreasing the power of the optical beam released into the pathway. The power controller may respond to a finding of a particular type of blockage in the pathway. The power controller 48 may include or affect the light source 34, the amplifier 36, a filter, e.g. a filter wheel, or other mechanism for manipulating the amount of optical beam power.

In addition to the transmission of optical beams, the transmitter station is often in communication with the receiver stations, other transmitter stations and/or a central station in the communication network at the communication interface 52. The communication interface 52 may use any of a variety of communication schemes to accept system management information, such as the status of a station; attenuation at various receiver stations, e.g. target and reference receiver stations; backscatter detection; parameter control instructions, e.g. directions to adjust power of an optical beam, filter strengths, etc. These communication schemes may include electrical wire links, e.g. T1 connection, use of radio frequency or optical frequency from a communication source employing any of the numerous communication standards used in the telecommunication industry. For example, communication may be through a network, e.g. an Internet connection, satellite transmission, Ethernet connection and other communication links for transferring information or control instructions to and/or from any of the stations in the optical communications system. Furthermore, transmission of status and control information may be made through encoded into an optical beam with in-band system management information integrated into the band received by the transmitter station, e.g. through the communication interface or other detector.

Furthermore, the transmitter station may include a monitor 50 to detect backscattering of the optical beam. Typically, the detected backscatter amount will be normalized by the transmitted power amount from the transmitter station so that the processed backscatter signal is independent of the transmitted power amount. The monitor may also be used for evaluating a sample of the optical beam, such as beam shape, power, etc. One such monitor utilizes a lock-in amplifier following the optical-to-electrical signal detection, that applies phase sensitive detection to filter out noise, i.e. improve signal to noise ratio, and increase phase sensitivity of the optical power detected. A lock-in amplifier uses the process of synchronous (or phase sensitive) detection to recover signals that have been buried in noise. The component acts as an extremely narrow pass band filter with the center point of the pass band selected by a reference signal.

Another optional component is a tracking unit, such as a quad detector or device having an array of sensors, e.g. camera-based sensor, which assists in tracking of the optical beam to the receiver station's aperture. In the quad detector embodiment, the detector is sectored into four equal portions and a portion of the optical beam from the receiver station is made to hit the center of the quad detector which coincides with the shared vertex of the four sections. If the beam hits outside of the center point, the tracking is off and may be adjusted. In some embodiments, the tracking unit, e.g. quad detector, also serves as the monitor 50 to detect and determine backscatter.

Various components may also be present in the transmitter station to direct the beam to various other components. The transmitter station may contain beam splitters to direct a portion of the beam to another transmitter station component, such as a tracking unit or monitor. In addition, mirrors may be provided to direct the beam to certain components.

FIG. 2 demonstrates one embodiment of a transmitter station, the scope of the present invention anticipates that in other embodiments, transmitter components may be arranged in various fashions within the transmitter station or outside of the transmitter station and coupled to the transmitter via fiber links or other communication mechanisms. For example, modulator 54 may be in the optical generator in a position prior to or after the light source 34. Furthermore, the optical generator may be external to the transmitter station and be coupled to the transmitter by a fiber, which transports the light to the transmitter.

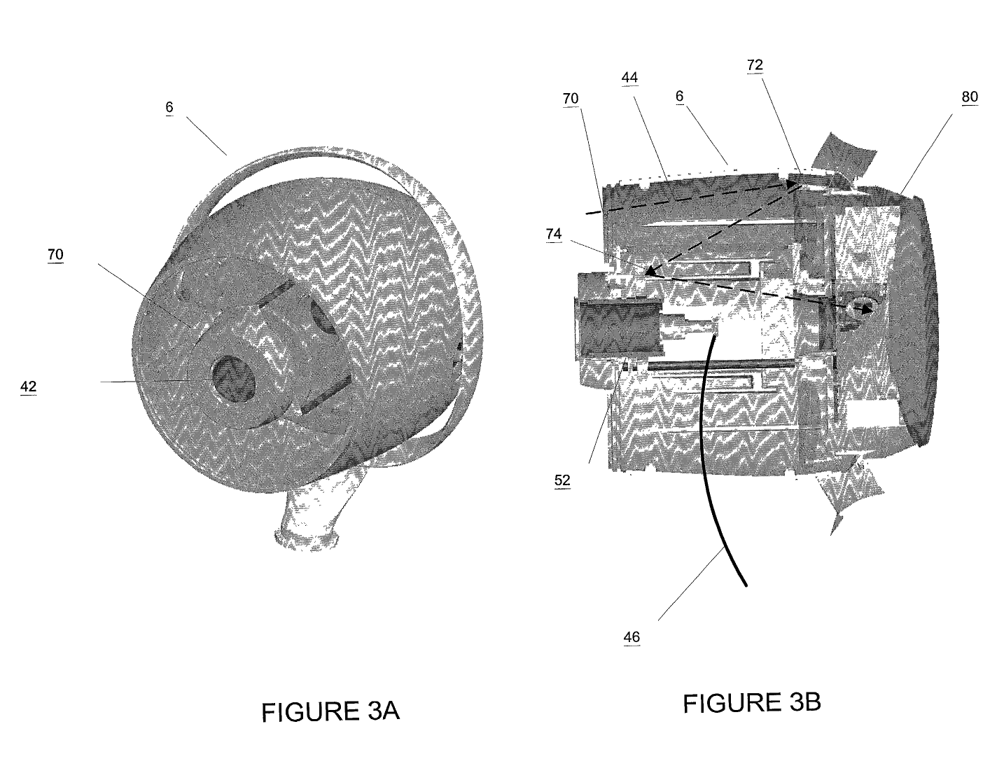

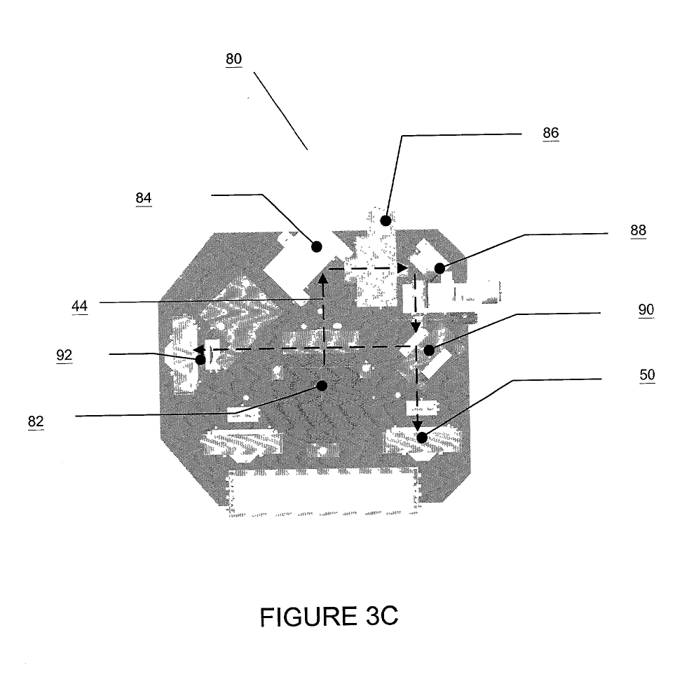

In general, the target receiver station has light gathering and filtering elements and at least one optical detector and may include a tracking device, demultiplexing components and decoding circuitry. In addition, the reference receiver station has all or most of the same components as the target receiver station. FIGS. 3A, 3B and 3C show various views of a receiving station 6 that also includes transmitter components 52 as described above for the transmitter station 4 and a fiber 46 extending from the transmitter components 52.

FIG. 3A shows the external view of a receiver station that includes a receiver aperture 70 for collecting the optical beam from the pathway. A transmitter aperture 42 may also be present where the receiving station also sends optical beams. As shown by the internal view of the receiving station 6 in FIG. 3B, the optical beam 44 enters through the receiving aperture 70 and reflects off of a series of mirrors, e.g. primary mirror 72 and secondary mirror 74. The mirrors direct the optical beam 44 to the detecting end 80 of the receiving station for detection.

FIG. 3C shows one embodiment of the detecting end 80 having a receiving point 82 for entry of the optical beam 44. A steering mirror 84 reflects that optical beam onto a focusing lens 86. The focusing lens passes the light beam to a fold mirror 88. The light beam may optionally continue to a beam splitter 90, which splits a portion of the optical beam to a detector 92 for measurement and a portion of the optical beam to a monitor 50 which may also function as a tracking sensor. Usually the detector may sense light in the nano watts level or smaller, such as pico watts amounts. The monitor 50 is an optional component for evaluating a sample of the optical beam, such as beam shape, amount of power, backscattering detection, etc. The monitor is especially useful where the transmitter station incorporates the components of the receiving station.

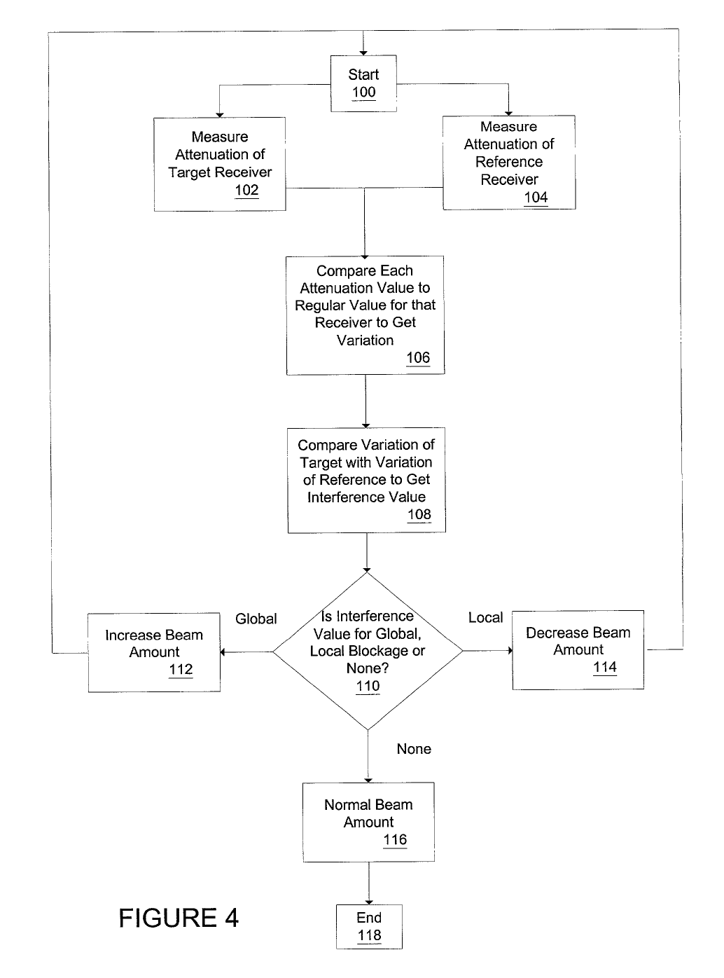

In addition, various other components may be provided in a receiver station and/or transmitter station, such as one or more lenses, filters, mirrors or beam splitters. FIG. 4 shows one variation of a split beam transmitter station 100 for sending multiple optical beams 112, 122, 132 created by at least one optical generator 102 into discrete pathways 110, 120, 130, respectively. The transmitter station has an optical generator 102 component and fiber 105 leading to multiple releasing ends, e.g. a primary releasing end 106 to send the primary optical beam 112 in pathway 110 to target receiving station 108, and other releasing ends 138. Each releasing end may have a beam shaper unit and has a transmitter aperture (not shown), which sends an optical beam to a reference receiver 140. A beam splitter 104 divides the light into the appropriate number of beams for each releasing end. Individual reference receiver stations 118, 128 may also be associated with each releasing end of the transmitter station 100 as a component of the transmitter station or as a receiver station that is external (not shown) to the transmitter station. The native receiving stations 118, 128 of the transmitter station 100 accept optical beams 116, 126, 136 along pathways 114, 124, 134, respectively from transmitters 142.

To determine a blockage for this particular embodiment of split beam transmitter station having numerous receiver stations, a primary optical beam 112 may be transmitted from primary releasing end 106 into pathway 110. The transmitter station may examine native associated receiver station 118 that is associated with the primary releasing end 106 for any attenuation above acceptable or normal limits. Where an above threshold attenuation is found either in the native associated reference receiver station 118 or in target receiver station 108, the transmitter station may determine that a blockage is present. Consequently, the transmitter station may opt to poll one or more other native reference receiver stations 128 within the transmitter station or remote reference receiver stations 140 distant from the transmitter station, in order to determine the nature of the blockage and the appropriate change of system parameter action relative to the pathways affected by the blockage. The transmitter station may also opt to poll other transmitter stations in the network.

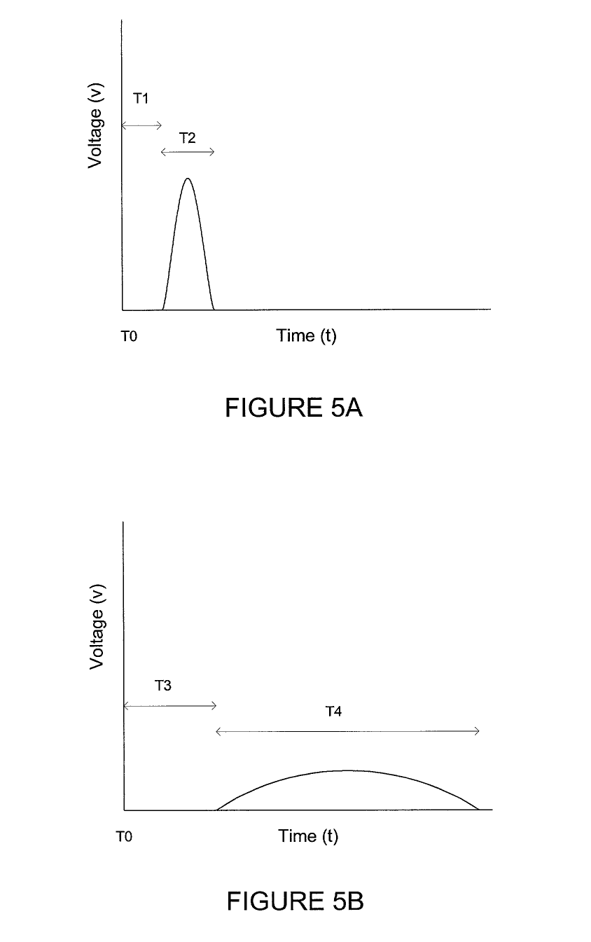

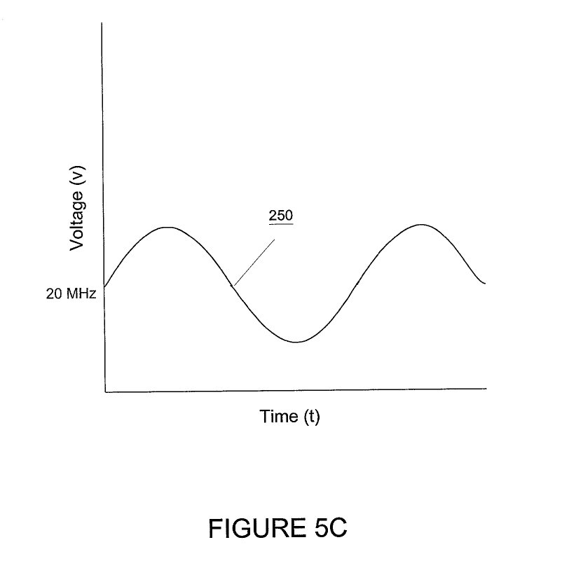

As shown in the flow diagram of FIG. 5, one method of determining blockage is by measuring attenuation of the optical beam arriving at the target receiver station at a period of time 152. The attenuation is compared to a regular value of attenuation for that target receiver station 154. The regular value may be the average amount of attenuation for a given period, the typical amount of attenuation determined to occur in a particular day of the year and time of day, or other convenient standards based on predicted power received without the blockage. The regular value is measured by characterizing the link and taking into account daily common sources of link loss, such as windows, range loss, fiber loss, etc. If the result of the comparison with the regular value determines an unacceptable measured attenuation, which may be a range of amounts or any amount, a blockage is indicated 156. If there is no blockage, the normal operations continue 172 and the procedure ends 174. At any time the procedure may begin again. Often the procedure reiterates on a regular, prescheduled basis, such as every second.

Where a blockage is indicated, the system may opt to query reference receiver(s) to determine the type of blockage and possibly make corrective changes in parameters. For the same time period that is being studied regarding the target receiver, the attenuation of another optical beam of at least one reference receiver station is measured 158. The resulting value for each receiver station is compared to a regular value for that receiver station to determine a variation attenuation value for the period of time 160. If the variation attenuation value is greater than a pre-defined tolerable amount, e.g. over 4 dB, over 10 dB, over 50 db, or other amounts, then a blockage is suggested at that site 162.

In other embodiments, where more than one reference receiver station is used, the average variation attenuation value may be determined and compared to attenuation at the target receiver. This averaging process may factor in the distance that a reference receiver is located relative to the target reference receiver, power levels, and other factors. For example, the value of a closer reference receiver station may be caused to have greater impact on the average than the value from more remote reference receiver stations.

In a further alternative embodiment, the variation attenuation value of the reference receiver station(s) 160 is compared to the variation attenuation amount of the target reference 154 to result in an interference value that is caused by a blockage. This interference value specifies whether the attenuation at the reference receivers is similar or the same as the attenuation at the target receiver, thereby indicating a global blockage, or sufficiently different to suggest a local blockage. This comparison may factor in any difference in power levels of the transmitted optical beams and difference of reference pathway length(s) and target pathway length, and the like. A range of tolerable variances may also be considered in the comparison process to account for microclimate effects and other causes of error.

If there is a blockage at that reference receiver station, then a global blockage is suggested 164. Otherwise, a local blockage may be interpreted to be present 166. At this point, the system may decide that a system parameter should be altered. The decision to change a parameter may be based, inter alia, on many aspects of the communication system, classes for optical beams and their safety regulations, goals for the transmission, etc.

The communication system may respond to a particular type of blockage by authorizing the adjustment of certain system parameters that may affect the primary transmitter station, target receiver and/or any of the reference receivers. For example, a global blockage may cause the system to increase the power amount of the optical beam by increasing the power of the light in forming the optical beam at the transmitter station, decreasing filtering or attenuation at the transmitter station or by decreasing the filtering or attenuation amount at the receiver station. In the alternative, a decision may be made to maintain power amounts where a global blockage is determined. The decision to increase the power of the optical beam may be based on the sensitivity of the system. In some systems, the link performance is maintained even with a significant percentage of the beam being blocked. For example, a link may be continue to be available even if over 90% of the beam is blocked and resulting in a 10 dB reduction in link margin. For a local blockage, the system may opt to decrease the amount of power in the optical beam, such as for safety considerations, by decreasing power at the transmitter station 100. In the alternative, a decision may be made to maintain power amounts where a local blockage is determined. In addition, where the attenuation is decidedly caused by a blockage, the transmitter station and/or receiving station may not vary the tracking system to better align the focus of the optical beam onto the receiving aperture when the blockage is removed.

However, an operation parameter change may not accompany every indication of a particular type of blockage. For example, a local blockage may be detected, but where the current optical beam is within allowable levels for the blockage, a decision to maintain steady power amounts may be made.

The system may decide that it has sufficient information regarding the blockage type and scope. The process may simply end 174. In some cases, where an operation parameter was changed, the system may return to normal operations 172 prior to ending 174.

In order to make a more accurate determination of the blockage type, the system may opt to poll other receiver stations 170. For example, where a global blockage is possible, the system may want to ensure that no local blockage is present prior to opting to increase power. The process of measuring 158 and comparing values 160 for another reference receiver is repeated, until the system chooses not to continue polling, for example, if it is determined that there is no longer a blockage present or a global blockage is insignificant enough to ignore. The power may return to or remain at normal 172, e.g. optimal or default levels for the system and the process ends 174.

The system may be configured to test whether the blockage is gone and it is safe to return to normal or different operations. In one embodiment, after the optical beam power is decreased due to a local blockage, the transmitter station increases the power of the beam by small increments or sends quick pulses of increased power, such as to avoid exceeding safe exposure limits, and repeats the detecting of attenuation and comparing the attenuation to reference receiver(s) with each power increment or pulse level. If no local blockage is found, the power increase and check for blockage may be reiterated until the optical beam is at an optimal power amount for the system. This optimal amount of power depends on various factors that influence the receipt of the optical beam, such as distance, sensitivity of the receiving detector, established standards for optical communications, and weather conditions, etc. For example a low optimal power amount may be preferred for a clear day

In one embodiment, the target receiver selects portions of the received optical data stream for output to a user optical transceiver interface output, which in turn, may be connected via a high-speed networking connection to user equipment, which may include data routing circuits. The data routing circuits direct the data to node addresses, via free space optical backbone network-to-network links or anywhere on other networks connected to the routing circuitry.

When the optical beam hits a blockage or other scattering sources, often the light is scattered in various directions including back toward the transmitter station. The transmitter station may detect such backscattering to also distinguish between typical local, a fixed source, i.e. that is not temporarily present, global blockages, other distributed scattering sources along the path to the receiving station and scattering from a receiving station. The transmitter station may have an external monitor capability, such as a transmissometer, or other such device to measure the amount of light extinction over the length of the distance from the blockage scattered back to the transmitter station.

In one embodiment, the optical beam conveyed from the transmitter station may be pulsed at a convenient rate and the backscatter intercepted by the monitor. As the pulsed beam contacts a local blockage, the backscatter will hit the monitor at a particular time, depending on distance from the transmitter station that the local blockage is located, the type of local blockage, e.g. the reflective surface of the blockage, the power of the optical beam, etc. Often, the local blockage is near to the transmitter station and the backscattering enters the monitor very soon after it is transmitted, e.g. 10 nsec. The pulsing permits the monitor to track the distance that a blockage is located according to the time in which the backscatter is collected relative to the time that it is transmitted into the pathway.

In addition, a local blockage typically consumes only a small and defined portion of the pathway. By contrast, a global blockage or other distributed scattering source along the path usually invades much or the entire length of the pathway. The monitor may further be timed to open and accept only backscattered light from a predetermined point from the blockage. The transmissometer may be gauged to be open during the time range when a blockage may be present along the far end of the pathway and through a large span of the pathway. The monitor gate may be closed for round trip transit times that correspond to the distance within which a particular local near blockage or attenuator, such as a building window, often occurs. Thus, if the monitor detects backscatter during the open periods, a global blockage or other distributed scattering source is assumed. In addition, if the backscatter is detected over an extended period of time, then a fixed scattering source is determined to be present, rather than a source that may be removed, such as a person. This manner of measuring distance to a local blockage may be considered along with a known beam divergence amount and maximum permissible irradiance exposure conditions to determine a safe optical power level. Where a fixed source is determined, it may be decided that present conditions should be maintained, because a power sensitive blockage, such as a person or animal is not likely to be present.

Moreover, this timed monitoring embodiment may be employed to differentiate between fixed sources of attenuation, such as a window, and temporary sources, such as weather and a person, by measuring the backscatter. A fixed attenuation source results in a consistent backscatter pattern, i.e. measured amount of backscatter, at the same point along the pathway. An open gate monitor may indicate a nearby fixed source by the monitor accepting backscatter from only nearby or alternatively far away sources. The information regarding a fixed or temporary source may be further useful in deciding what, if any, changes should be made to system parameters. For example, it may be preferable to increase optical beam power where a fixed attenuation source is present but maintain or decrease power if a temporary source is detected.

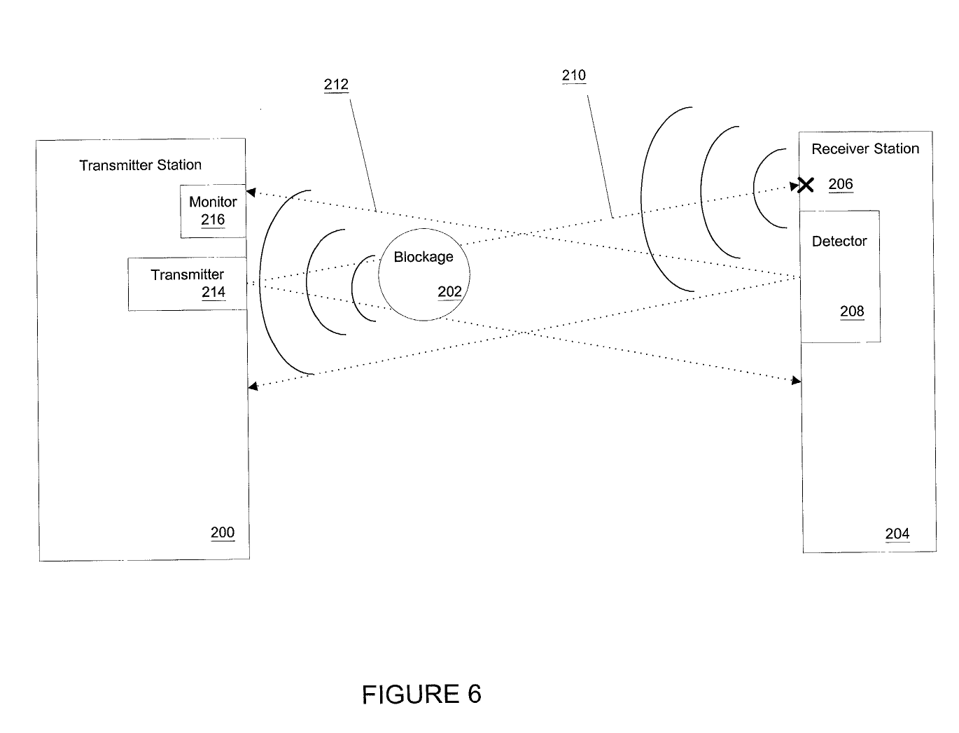

FIGS. 6A and 6B are graphs of an example of backscatter received by a monitor with a voltage over a period of time. In FIG. 6A, a local blockage creates a quick backscatter over time period T2 and occurs at a time T1 after the launch time T0 for sending the pulse. The monitor may be closed during the time T0 to the end of T2. As shown in FIG. 6B, backscatter detected by a monitor caused by a global blockage occurs at a time T3 and continues for a prolonged time period T4, representing the depth of the global blockage. The monitor may be opened for all or most of the time period T4, and usually is opened after T2.

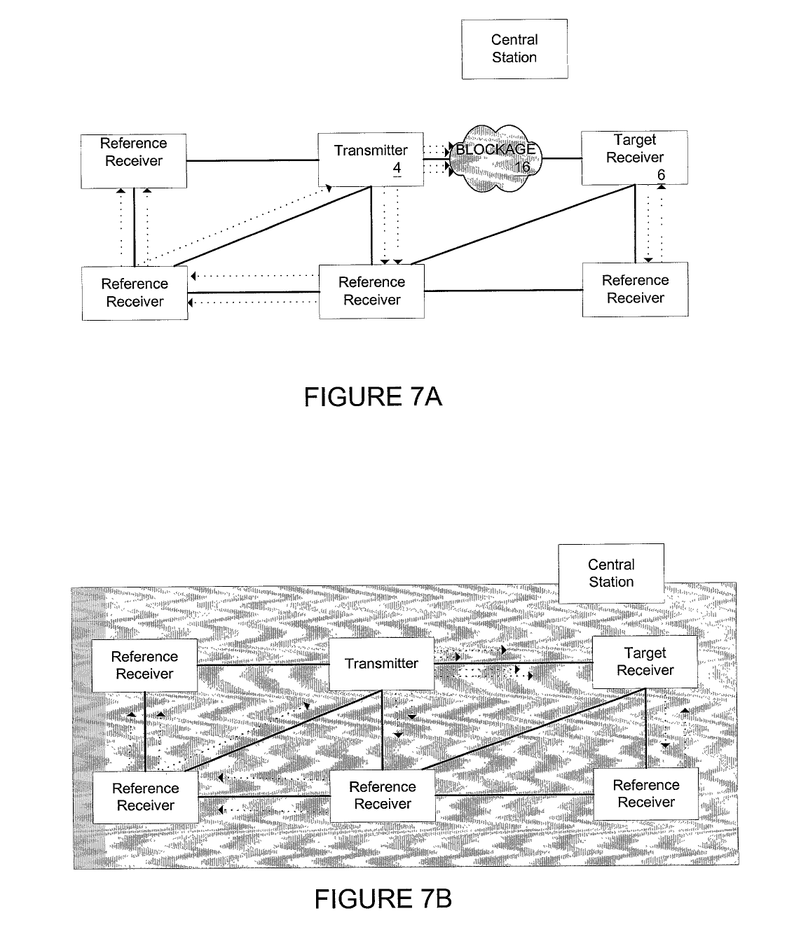

In still other embodiments as shown in FIG. 7, the transmitter station 200 may distinguish between backscatter from a blockage 202 and backscatter that may arise from the optical beam 210 leaving a transmitter aperture 214 and reflecting from the exterior 206 of the receiver station 204, such as the receiving aperture of the detector 208 or other surface. The monitor 216 determines the power of the backscattering, which is inversely proportional to the square of the distance of the blockage. Therefore, the amplitude of backscattering from a receiver station is much less than backscattering caused by a closer local blockage. Where the transmit signal is encoded with a reference modulator 54, the monitor may utilize a lock-in amplifier following the optical-to-electrical detection to achieve high sensitivity.

In some optical communication systems, the target receiver station 204 sends an optical beam 212 to the transmitter station along the same or different pathway down which the optical beam from the transmitter station travels. In this case, the transmitter station monitor 216 may distinguish between the optical beam received from the receiver station and backscatter from a blockage. A modulator 54 may create cyclic partial modulations in the power of the outgoing optical beam. This partial modulation for distinguishing between backscatter and other light is in addition to modulation of the optical beam used for carrying data or other information. The monitor is programmed to only detect the modulated backscatter that is matched to the transmitter station modulation signal rather than an optical beam from the receiving station or other stray light. In one embodiment, an optical beam from the receiving station directed to or happening to find the transmitter station is not modulated. In another embodiment, an optical beam from the receiving station has a substantially different modulation signal than the outgoing optical beam from the transmitter station. The use of a lock-in amplifier based sensor or other matched-filter receiver may have adequate dynamic range on the input and sufficient frequency isolation to avoid a false backscatter reading.

FIG. 6C depicts a graph of modulation cycles for an optical beam with voltage that fluctuates over a period of time. The monitor detects an envelope 250, i.e. one modulation cycle. For example, where detection is at 20 KHz modulation, then time for an envelope is the inverse of modulation, or 1/20 msec, i.e. 50 sec. A typical signal equals a modulation constant multiplied by the power of the backscatter plus background. Through the modulation procedure the background is ignored and only the power times the modulation constant is considered.

In still other alternative embodiments of an optics communications system, a beacon light, such as visible light, e.g. 550 nm, is projected by either the receiver station(s) or transmitter station. The opposing station includes a camera to view the pathway and detect the beacon light. The image captured by the camera is evaluated for determining whether a blockage is present and the type of blockage. For example, the present of fog may result in a hazy image of the beacon light.

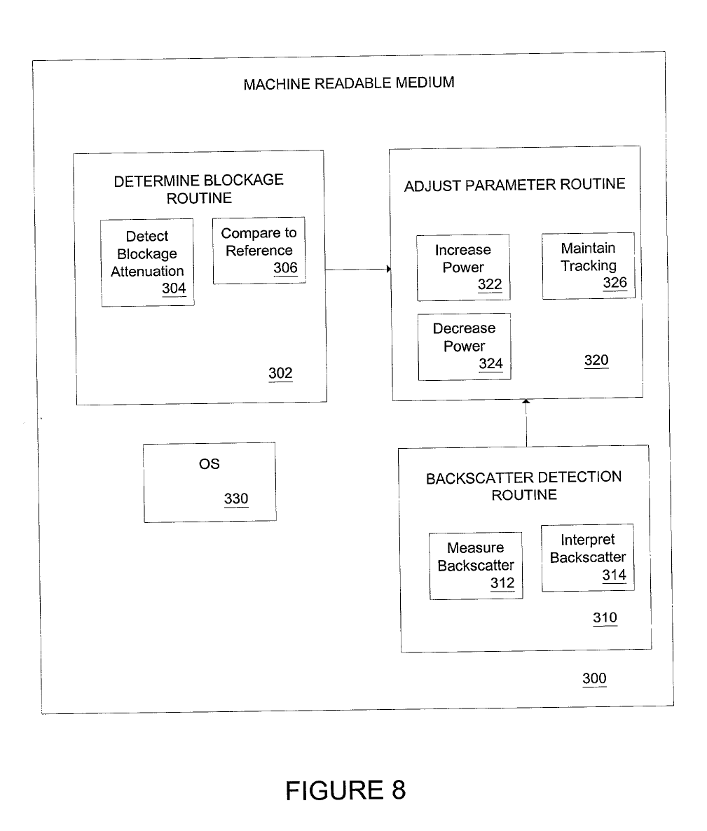

As shown in one embodiment of a multiple-station, interconnected communications system in FIGS. 8A and 8B, various stations, i.e. transmitter station 4, target receiver station 6 and/or reference receiver(s) 8, may serve as transceiver nodes to both send an optical beam and accept an optical beam from the target receiver or any of the reference receivers. For example, the transmitter station 4 may send optical beam 12 and accept other optical beams 16. The target receiver 6 may also accept an optical beam from other reference receivers (transceivers) or transmitters in addition to or in place of receiving signals from transmitter station 4. In FIG. 8A, a local blockage 18 is present and in FIG. 8B a global blockage is present.

The primary transmitter station may include reference components, which may serve as a reference receiver to accept an optical beam from the target receiver and/or reference receiver(s). In operation of this embodiment, the primary transmitter station may consider the attenuation information from the primary transmitter's own reference receiver for an incoming optical beam to determine a blockage and the nature of such a blockage. For example, the primary transmitter station may first detect attenuation at its native reference receiver of an optical beam released from the target receiver station. Upon detecting attenuation, the primary transmitter station may query the target receiver station to determine if attenuation is also present at the target receiver. If such attenuation is determined, then a blockage is determined to be present. To assess the type of blockage, the primary transmitter station may opt to poll for attenuation at one or multiple other reference receiver stations in the communication system network. In addition, the primary transmitter station may alternatively poll for attenuation at one of multiple other transmitter stations or transmitter/receiver pairs in the communication system network.

The communications system may also optionally have a central station 22 to monitor the transmitter station(s) and various receivers. It is further intended that the user transaction system may include any number of central stations, including no central stations 22.

The central station 22 may communicate with the receivers and transmitter station through various network communication schemes. In one embodiment, the link may be a T1 connection. The central station may gather data regarding the transmission and attenuation at the various receivers/transmitter stations. The central station may use this data to determine a proper course of action for the stations and direct the stations to behave accordingly.

In one embodiment, the central station also normalizes visible light readings obtained in the general network location or close by, with the optical beam data to be used as reference data in determining the nature of a blockage. For example, transmission of visible light, e.g. at about 532 nm (green visible light spectrum), such as the readings often acquired by airports, may be translated to the wavelength and characteristics of the optical beam, including the altitude of the beam compared to the visible light readings, and environmental factors between sites, such as temperature, humidity, wind speed, particulate levels, air pollution, etc. The optical transmission may be compared to the visible light readings for the same time period to determine a global blockage. In addition, weather patterns may be predicted by using past visible light data for a particular time as a factor in determining a future or present occurrence of a global blockage.

FIGS. 8C and 8D show another embodiment of a multiple-station, interconnected communications system in which transmitter/receiver pairs 324, 328, 330 and 332 are located within a sub-network 21, such as a local area network (LAN) for a business, school, organization, etc., e.g. within a building, campus, etc., having a central station 322. The resident nodes, i.e. transmitter/receiver stations, of the sub-network 21 are in communication with the central station through an Ethernet link or other convenient short distance communication scheme.

During operation, the central station 322, may receive attenuation information from the resident primary transmitter/receiver pair 324. The central station 322 may then opt to sequentially poll one or more of the resident reference receiver/transmitter pairs 328, 330 and 332 that are within the sub-network. The central station 322 may also choose to poll the remote target receiver/transmitter pair 326 and/or the remote reference receivers 334, i.e. on the receiving end of the transmitters within the sub-network, especially where further information is needed to make a system parameter decision. For example, if there is a blockage indicated at the primary transmitter/receiver pair but none of the resident reference receiver stations show attenuation amounts that indicate a global blockage, the central station may poll the remote target receiver and possibly the remote reference receivers to determine if a local blockage is present. FIG. 8C depicts the presence of a local blockage 16 and FIG. 8D illustrates a global blockage.

Various software components, e.g. applications programs, may be provided within or in communication with an optical communication system device such as the central station, transmitter station and/or receiving station that cause the device to execute the numerous methods employed for determining the nature of a blockage and adjust system parameters in response to the determining, including sending instructions for such parameter adjustment. An optical communication system, e.g. a processor, executes the computer-readable medium, which may be locally or remotely located relative to the processor. FIG. 9 is a block diagram of a computer readable, i.e. machine-readable, medium storing executable code and/or other data to provide one or a combination of mechanisms to transmit and analyze light, according to one embodiment of the invention. The machine-readable storage medium 400 represents one or a combination of various types of media/devices for storing machine-readable data, which may include machine-executable code or routines. As such, the machine-readable storage medium 400 could include, but is not limited to one or a combination of a magnetic storage space, magneto-optical storage, tape, optical storage, dynamic random access memory, static RAM, flash memory, etc. Various subroutines may also be provided. These subroutines may be parts of main routines or added as plug-ins or Active X controls.

The machine readable storage medium 400 is shown having a determining blockage routine 402, which, when executed, detects a blockage through measuring attenuation of a received optical beam by a detect blockage attenuation subroutine 404. Thee program further compares attenuation at the target receiver with attenuation at one or more reference receiver stations through a compare subroutine 406, as described above with reference to the method flow chart in FIG. 5.

The medium 400 may also optionally have a backscatter routine 410 used to determine the nature of a blockage by detecting and analyzing backscatter of an optical beam through implementing any of several subroutines. The measure backscatter subroutine 412 may be executed to quantify an amount of received backscatter and a compare backscatter subroutine 414 may interpret the backscatter amount to standards for a local blockage and/or a global blockage to determine the nature of the blockage. The routine and subroutines for backscatter monitoring is described above with reference to FIGS. 6A to 6C.

In addition, the medium may also include an adjust parameter routine 420, which may be executed through a variety of optional subroutines to vary the system parameters as triggered by the determination of a particular type of blockage as determined by the other routines. An increase power subroutine 422 allows the optical beam to be released with greater power or collected having greater power, e.g. decrease filtering or attenuation at the transmitter station or target receiver station, especially where the blockage is established to be global in nature. The decrease power subroutine 424 permits the optical beam to be released with less power, especially when the blockage is interpreted to be local. In some embodiments, a maintain tracking subroutine 426 is provided to restrict movement or refocusing of a transmitter station or receiving station where disruption is due to a blockage event. Such adjusting procedures are described above with regards to FIG. 5.

In addition, other software components may be included, such as an operating system 430.

The software components may be provided as a series of computer readable instructions that may be embodied as data signals in a carrier wave. When the instructions are executed, they cause an optical communication system device, e.g. a transmitter station, receiver station and/or central station, to perform the blockage determining and adjusting steps as described. Such instructions may be presented to the processor by various mechanisms, such as a plug-in, ActiveX control, through use of an applications service provided or a network, etc.

The present invention has been described above in varied detail by reference to particular embodiments and figures. However, these specifics should not be construed as limitations on the scope of the invention, but merely as illustrations of some of the presently preferred embodiments. It is to be further understood that other modifications or substitutions may be made to the described user transaction system as well as methods of its use without departing from the broad scope of the invention. Therefore, the following claims and their legal equivalents should determine the scope of the invention.

What is claimed is:

1. A method for communicating optical data in a network, the method comprising:
transmitting an optical beam carrying data into a wireless pathway to a target receiver station;
detecting an attenuation of the optical beam; and
comparing the attenuation of the optical beam with an attenuation of another optical beam intended to be received by at least one reference receiver station in the network to determine a global blockage or local blockage of the pathway.

2. The method of claim 1, further including increasing the power of the optical beam transmitted if there is a global blockage.

3. The method of claim 1, further including reducing or maintaining the power of the optical beam transmitted if there is a local blockage.

4. The method of claim 3, further including repeating the detecting of an attenuation and comparing the attenuation, and incrementally increasing the power of the optical beam if there is no local blockage with each repetition, until the power reaches a network based optimal amount.

5. The method of claim 1, further including measuring backscatter as an indication of a local or global blockage.

6. The method of claim 5, wherein the transmitting of an optical beam is by pulsing and further including detecting backscatter only during an extended period of time corresponding to backscatter from a global blockage.

7. The method of claim 5, further including distinguishing backscatter from a fixed source, a local blockage, a distributed scattering source along the pathway, and the reference receiving station, by the measured amount of backscatter.

8. The method of claim 5, wherein the transmitted optical beam is partially modulated to distinguish between backscatter and other light.

9. The method of claim 1, further including detecting an attenuation of another optical beam intended to be received by a reference receiver station native to the transmitter station, prior to the detecting of an attenuation of the optical beam.

10. The method of claim 1, wherein the comparing is by a central station and further including the central station sending instructions to the transmitter station or target receiver station to adjust a system parameter according to whether the blockage is local or global.

11. A transmitter station comprising:
a) a light source for generating an optical beam;
b) a transmitter aperture for sending the optical beam into a wireless pathway to a target receiver station;
c) a communication interface to receive information on the attenuation of the optical beam at the target receiver station and attenuation of another optical beam at a reference receiver station, as an indication of a local or global blockage of the pathway; and
d) a power controller to increase the optical beam in if there is a global blockage or decrease or maintain the optical beam if there is a local blockage.

12. The device of claim 11, further including a monitor to measure backscatter of the optical beam from a blockage of the pathway, wherein the measured backscatter indicates a global blockage or a local blockage.

13. The device of claim 12, wherein the sending of the optical beam is by pulsing and the measuring of backscatter is only during an extended period of time corresponding to backscatter from a global blockage.

14. The device of claim 12, wherein the measuring backscatter further indicates backscatter from a local blockage or backscatter from the receiving station.

15. The device of claim 12, wherein the optical beam is partially modulated to distinguish between backscatter and other light.

16. The device of claim 11, wherein the communication interface receives instructions to adjust the power controller from a central station according to whether the blockage is local or global.

17. A computer readable medium having stored therein a plurality of sequences of executable instructions, which, when executed by an optical communication system device for distinguishing between a local blockage and a global blockage, cause the device to:
a) detect a blockage of a pathway for an optical beam, and
b) compare the amount of power of the optical beam collected by a target receiver station at the pathway with the amount of power of an optical beam collected by at least one reference receiver station in the optical communication system to determine if the blockage is global or local.

18. The computer readable medium of claim 17, further including additional sequences of executable instructions, which, when executed by the optical communication system device cause the device to increase or maintain the amount of power of the optical beam transmitted if the blockage is global.

19. The computer readable medium of claim 17, further including additional sequences of executable instructions, which, when executed by the optical communication system device cause the device to reduce or maintain the amount of power of the optical beam transmitted if the blockage is local.

20. The computer readable medium of claim 17, further including additional sequences of executable instructions, which, when executed by the optical communication system device cause the device to measure backscatter as an indication of a local or global blockage.

21. The computer readable medium of claim 20, further including additional sequences of executable instructions, which, when executed by the optical communication system device cause the device to distinguish backscatter from a local blockage and backscatter from a distributed scattering source along the pathway or from the target receiver station by the measured amount of backscatter.

22. A method for, the method comprising:
transmitting an optical beam carrying data into a wireless pathway to a target receiver station;
detecting an attenuation of the optical beam;
comparing the attenuation of the optical beam with an attenuation of another optical beam intended to be received by at least one reference receiver station in the network to determine a global blockage or local blockage of the pathway;
increasing the amount of power of the optical beam transmitted if there is a global blockage; and
reducing or maintaining the amount of power of the optical beam transmitted if there is a local blockage.

23. The method of claim 22, further including repeating the detecting of an attenuation and comparing the attenuation, and incrementally increasing the amount of power of the optical beam if there is no local blockage with each repetition, until the power reaches a network based optimal amount.

24. The method of claim 22, further including measuring backscatter as an indication of a local or global blockage.

25. The method of claim 24, wherein the transmitting an optical beam is by pulsing and further including detecting backscatter only during an extended period of time corresponding to backscatter from a global blockage.

26. The method of claim 24, further including distinguishing between backscatter from a local blockage and backscatter from a distributed scattering source along the pathway or from the target receiving station by the measured amount of backscatter.

27. The method of claim 24, wherein the transmitted optical beam is partially modulated to distinguish between backscatter and other light.

28. The method of claim 24, further including detecting an attenuation of another optical beam intended to be received by a reference receiver station native to the transmitter station, prior to the detecting of an attenuation of the optical beam.

29. The method of claim 24, wherein the comparing is by a central station and further including the central station sending instructions to the transmitter station or receiver station to adjust a system parameter according to whether the blockage is local or global.
